(19) United States
(12) Patent Application Publication
(10) Pub. No.: US 2021/0106134 A1
(43) Pub. Date: Apr. 15, 2021

(54) Artificial Intelligence Refrigerated Tea Table

(71) Applicant: Jianjun Deng, Shenzhen (CN)

(72) Inventor: Jianjun Deng, Shenzhen (CN)

(21) Appl. No.: 16/740,514

(22) Filed: Jan. 13, 2020

(30) Foreign Application Priority Data
Oct. 14, 2019 (CN) 201910973940.1

(51) Int. Cl. A47B 31/02; G06N 20/00; A47B 9/10

(52) U.S. Cl. CPC A47B 31/02; A47B 2031/026; A47B 9/10; G06N 20/00

(57) ABSTRACT

The present invention provides an artificial intelligence refrigerated tea table. The artificial intelligence refrigerated tea table comprises: an upper cover unit; a lifting unit, which is provided below the upper cover unit, wherein a top end of the lifting unit is connected to the upper cover unit; a lower housing unit, which is provided below the upper cover unit, wherein a bottom end of the lifting unit is connected to the lower housing unit; an LED light unit and a button, wherein the LED light unit and the button are both provided on the upper cover unit. The artificial intelligence refrigerated tea table provided by the present invention has the functions of a tea table and a refrigerator, which can be used as a tea table as well as a refrigerator and can refrigerate water and beverage, etc. The implantation of artificial intelligence can interact with people, process human voice and immediately feed the corresponding result back, which is more intelligent and humanized in use.

### TECHNICAL FIELD

The present invention relates to the technical field of tea tables, in particular to an artificial intelligence refrigerated tea table.

### BACKGROUND

With the continuous progress of society and the development of science and technology, traditional tea tables cannot meet the various needs of consumers with a single function. Tea tables with artificial intelligence and refrigeration functions have not yet appeared on the market. Refrigerators with refrigeration functions are not suitable to be placed in the living room or to be placed in front of the sofa due to their large size. There are no tea tables with artificial intelligence and refrigeration function, which is placed in front of the sofa, on the market.

Therefore, it is necessary to provide an artificial intelligence refrigerated tea table to solve the above technical problem.

### SUMMARY

The technical problem solved by the present invention is to provide an artificial intelligence refrigerated tea table with the functions of a tea table and a refrigerator, which is more intelligent and humanized.

In order to solve the above technical problem, the artificial intelligence refrigerated tea table provided by the present invention comprises: an upper cover unit; a lifting unit, which is provided below the upper cover unit, wherein a top end of the lifting unit is connected to the upper cover unit; a lower housing unit, which is provided below the upper cover unit, wherein a bottom end of the lifting unit is connected to the lower housing unit; an LED light unit and a button, wherein the LED light unit and the button are both provided on the upper cover unit; a rotating beverage frame, an audio unit, a charging and USB unit, an artificial intelligence unit, a control unit, an anti-pinch hand unit, a refrigerating unit, a temperature control unit, and a bracket mechanism, wherein the rotating beverage frame, the audio unit, the charging and USB unit, the artificial intelligence unit, the control unit, the anti-pinch hand unit, the refrigerating unit, the temperature control unit, and the bracket mechanism are all provided on the lower housing unit.

Preferably, the artificial intelligence unit is connected to the control unit, the control unit is connected to the lifting unit, and a push rod lifting component is provided in the lifting unit.

Preferably, the audio unit is connected to the artificial intelligence unit.

Preferably, the control unit is connected to the lifting unit.

Preferably, the button is connected to the lifting unit.

Preferably, the button is connected to the lifting unit.

Preferably, the refrigerating unit is connected to the temperature control unit.

Preferably, the anti-pinch hand unit is connected to the control unit, and the anti-pinch hand unit has a built-in infrared sensor proximity switch.

Preferably, the bracket mechanism is an integrally formed trifurcated leg.

Preferably, the bracket mechanism comprises three supporting components, the three supporting components are all fixedly mounted at the bottom of the lower housing unit, the supporting component comprises a mounting block, the mounting block is provided with a cavity, a slider is slidingly mounted in the cavity, the cavity is provided with a spring, the top end and the bottom end of the spring are fixedly connected to the top end of the cavity and the top of the slider, respectively, a slide bar is fixedly mounted at the bottom of the slider, and a hemisphere base is fixedly mounted at the bottom end of the slide bar.

Compared with related technologies, the artificial intelligence refrigerated tea table provided by the present invention has the following beneficial effects.

The artificial intelligence refrigerated tea table provided by the present invention has the functions of a tea table and a refrigerator, which can be used as a tea table as well as a refrigerator and can refrigerate water and beverage, etc. The implantation of artificial intelligence can interact with people, process human voice and immediately feed the corresponding result back, which is more intelligent and humanized in use.

### BRIEF DESCRIPTION OF THE DRAWINGS

FIG. 1 is a schematic structural diagram of a first embodiment of an artificial intelligence refrigerated tea table according to the present invention;

FIG. 2 is a schematic structural diagram of a raised upper cover unit of an artificial intelligence refrigerated tea table as shown in FIG. 1;

FIG. 3 is a schematic diagram of a three-dimensional structure of a raised upper cover unit of an artificial intelligence refrigerated tea table as shown in FIG. 1;

FIG. 4 is a schematic structural diagram of a second embodiment of an artificial intelligence refrigerated tea table according to the present invention;

FIG. 5 is a schematic cross-sectional structure diagram of part A in FIG. 4.

Reference numbers in the figures: 1, an upper cover unit, 2, an LED light unit, 3, a lifting unit, 4, a rotating beverage box, 5, a lower housing unit, 6, an audio unit, 7, a charging and USB unit, 8, an artificial intelligence unit, 9, a control unit, 10, an anti-pinch hand unit, 11, a drawer, 12, a button, 13, a refrigerating unit, 14, a temperature control unit, 15, a bracket mechanism, 16, a mounting block, 17, a slider, 18, a spring, 19, a slide bar, 20, a hemisphere base.

### DESCRIPTION OF THE EMBODIMENTS

The present invention is further described below with reference to the accompanying drawings and embodiments.

### A First Embodiment

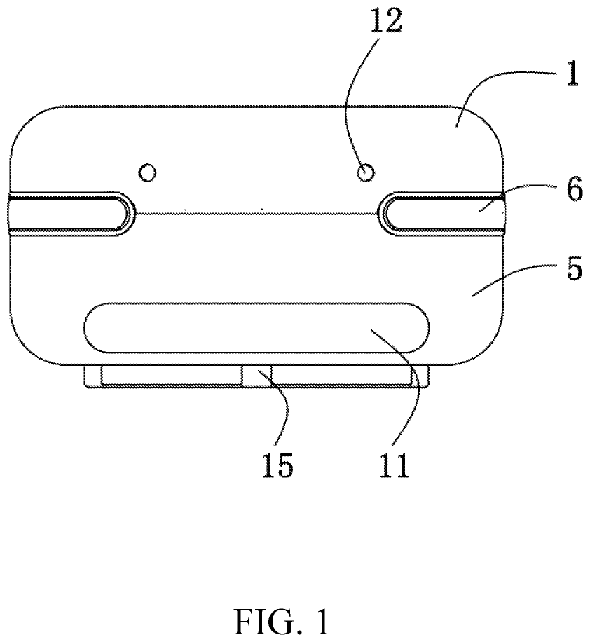

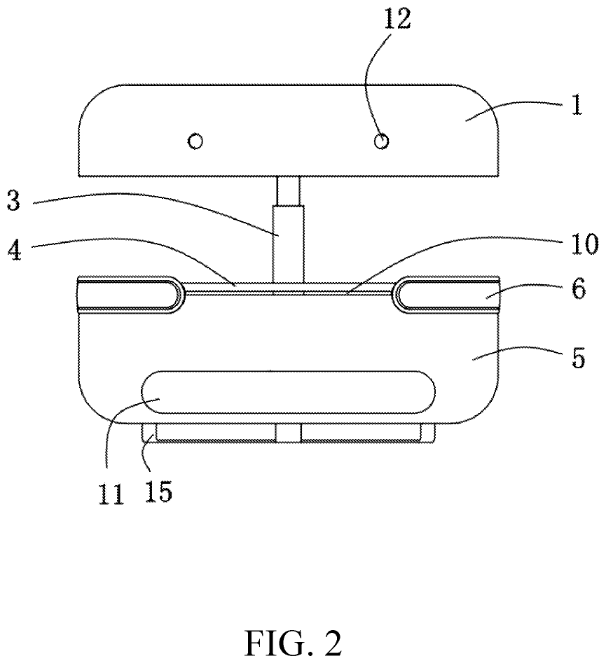

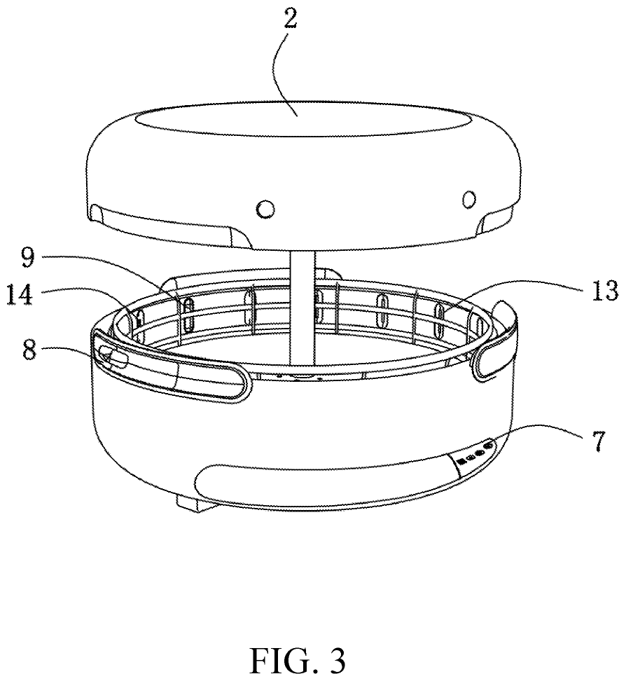

With reference to FIGS. 1-3, in the first embodiment of the present invention, the artificial intelligence refrigerated tea table comprises: an upper cover unit 1; a lifting unit 3, which is provided below the upper cover unit 1, wherein a top end of the lifting unit 3 is connected to the upper cover unit 1; a lower housing unit 5, which is provided below the upper cover unit 1, wherein a bottom end of the lifting unit 3 is connected to the lower housing unit 5; one end of the lifting unit 3 is connected to the upper cover unit 1 and the other end thereof is connected to the lower housing unit 5 and the control unit 9, the control unit 9 can issue the instruction to open the upper cover or close the upper cover, when the control unit 9 issues the instruction to open the upper cover, the lifting unit 3 will rise to open the upper cover unit, and when the control unit issues the instruction to close the upper cover, the lifting unit 3 will descend to close the upper cover unit 1, and open the upper cover and close the upper cover; an LED light unit 2 and a button 12, wherein the LED light unit 2 and the button 12 are both provided on the upper cover unit 1; a rotating beverage frame 4, an audio unit 6, a charging and USB unit 7, an artificial intelligence unit 8, a control unit 9, an anti-pinch hand unit 10, a refrigerating unit 13, a temperature control unit 14, and a bracket mechanism 15, wherein the rotating beverage frame 4, the audio unit 6, the charging and USB unit 7, the artificial intelligence unit 8, the control unit 9, the anti-pinch hand unit 10, the refrigerating unit 13, the temperature control unit 14, and the bracket mechanism 15 are all provided on the lower housing unit 5.

The artificial intelligence unit 8 is connected to the control unit 9, the control unit 9 is connected to the lifting unit 3, and a push rod lifting component is provided in the lifting unit 3. The artificial intelligence unit 8 analyzes the user's voice and issues a signal to the control unit 9. The control unit 9 sends an instruction to the lifting unit 3 after receiving the signal. After the lifting unit 3 receives the instruction, the push rod lifting component will rise and descend accordingly.

The audio unit 6 is connected to the artificial intelligence unit 8. The audio unit 6 is placed in the lower housing unit 5, and a power amplifier and a speaker are included therein. The artificial intelligence unit 8 is connected to the audio unit 6. After the internet is connected, the human voice can be used to intelligently search for and play music on various platforms through artificial intelligence. After being connected to the audio unit 6 via Bluetooth, the music in the mobile phone is then played by the audio unit.

The control unit 9 is connected to the lifting unit 3. The control unit 9 is wirelessly connected to a remote control or a mobile phone APP. After the control unit 9 receives an instruction from the remote control, the control unit 9 will issue an instruction to open the upper cover, and the lifting unit 3 will rise to open the upper cover unit 1. When the control unit 9 issues the instruction to close the upper cover, the lifting unit 3 will descend to close the upper cover unit 1. A remote control controls the opening and closing of the upper cover unit 1. The control unit 9 is provided with a time delay function in addition to controlling the upper cover unit 1 to rise and descend. When the upper cover unit 1 has not been closed for a long time to reach a warning value, the control unit 9 will issue an instruction, and the lifting unit 3 will lower the upper cover unit 1 to ensure the temperature required for the beverage inside the tea table.

The button 12 is connected to the lifting unit 3 to control the lifting state of the push rod component. The button 12 is used to control the opening and closing of the upper cover unit 1. The lifting of the lifting unit 3 can be realized in three methods, that is, manual button lifting, artificial intelligence lifting and remote control lifting.

The refrigerating unit 13 is connected to the temperature control unit 14. The temperature control unit 14 can automatically adjust and control the temperature or manually adjust and control the temperature. After reaching a preset value, the temperature control unit 14 will instruct the refrigerating unit 13 to be on standby. The temperature control unit 14 monitors the internal temperature of the device at any time. After the temperature changes, it instructs the refrigerating unit 13 to start, and the process will be repeated in this way.

The LED light unit 1 is connected to the artificial intelligence unit 8. When the microphone in the artificial intelligence unit 8 receives a voice, the LED light unit 1 will flash accordingly. When music is played, the LED light unit 1 will flash with the rhythm of the music.

The anti-pinch hand unit 10 is connected to the control unit 9, and the anti-pinch hand unit 10 has a built-in infrared sensor proximity switch. When the control unit 9 issues an instruction to descend the upper cover unit 1, the anti-pinch hand function starts. When the anti-pinch hand unit 10 detects that a hand or another object has not left the edge of the lower housing unit 5, the built-in infrared sensor proximity switch will issue a warning to stop descending to the control unit 9. The control unit 9 will issue an instruction to the lifting unit 3, and the lifting unit 3 will immediately stop the operation and change the descending operation to the rising operation to prevent pinching hands or other objects.

The bracket mechanism 15 is an integrally formed trifurcated leg, and the bracket mechanism 15 supports the lower housing unit 5.

The working principle of the artificial intelligence refrigerated tea table provided by the present invention is as follows.

The LED light unit 2 is placed in the upper cover unit 1. When music is played, the LED light unit 2 will continuously flash with the rhythm of the music.

The audio unit 6 is placed in the lower housing unit 5, and a power amplifier and a speaker are included therein. When the mobile phone is connected to the audio unit via Bluetooth, the music in the mobile phone is then played by the audio unit. The user can also connect the internet and use the human voice to intelligently search for and play music on various platforms through artificial intelligence.

The artificial intelligence unit 8 is placed in the lower housing unit 5. After the microphone detects external voice, the built-in processor performs voice analysis. When the analysis result is consistent with the built-in rising voice, the control unit 9 will issue a rising instruction, so that the lifting unit 3 lifts the upper cover unit 1. Otherwise, the upper cover unit 1 will be descended to achieve the purpose of controlling the upper cover unit with voice. The implantation of artificial intelligence can help users handle daily tasks such as checking the weather, setting an alarm, planning a daily schedule, controlling your intelligent home devices, reminding you to exercise, calling you, finding your lost phone, turning TV on or off, letting it tell stories, listening to jokes, etc.

The control unit 9 is provided with a time delay function in addition to controlling the upper cover unit to rise and descend. When the upper cover unit 1 has not been closed for a long time to reach a warning value, the control unit 9 will issue an instruction, and the lifting unit 3 will lower the upper cover unit 1 to ensure the temperature required for the beverage inside the tea table.

The anti-pinch hand unit 10 and the built-in infrared sensor proximity switch are provided. When the control unit issues an instruction to descend the upper cover unit 1, the anti-pinch hand function starts. When detecting that a hand or another object has not left the edge of the lower housing of the tea table, the built-in infrared sensor proximity switch will issue a warning to stop descending to the control unit. The control unit 9 will issue an instruction to the lifting unit, and the lifting unit 3 will immediately stop the operation and change the descending operation to the rising operation to prevent pinching hands or other objects.

The rotating beverage frame 4 is placed in the lower housing unit 5 and the lifting unit 3 passes therethrough. When an external force pushes the rotating beverage frame 4, the rotating beverage frame will rotate freely around the lifting unit 3, which allows the user to conveniently select a favorite beverage.

Compared with related technologies, the artificial intelligence refrigerated tea table provided by the present invention has the following beneficial effects.

The artificial intelligence refrigerated tea table provided by the present invention has the functions of a tea table and a refrigerator, which can be used as a tea table as well as a refrigerator and can refrigerate water and beverage, etc. The implantation of artificial intelligence can interact with people, process human voice and immediately feed the corresponding result back, which is more intelligent and humanized in use.

### A Second Embodiment

Based on the artificial intelligence refrigerated tea table provided by the first embodiment of the present application, the second embodiment of the present application proposes another artificial intelligence refrigerated tea table. The second embodiment is only a preferred manner of the first embodiment, and the implementation of the second embodiment will not affect the separate implementation of the first embodiment.

The second embodiment of the present invention will be further described below with reference to the accompanying drawings and embodiments.

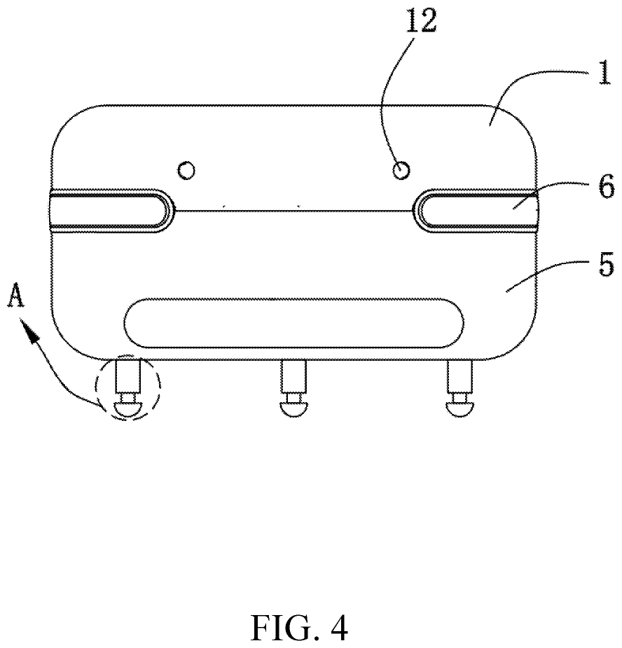

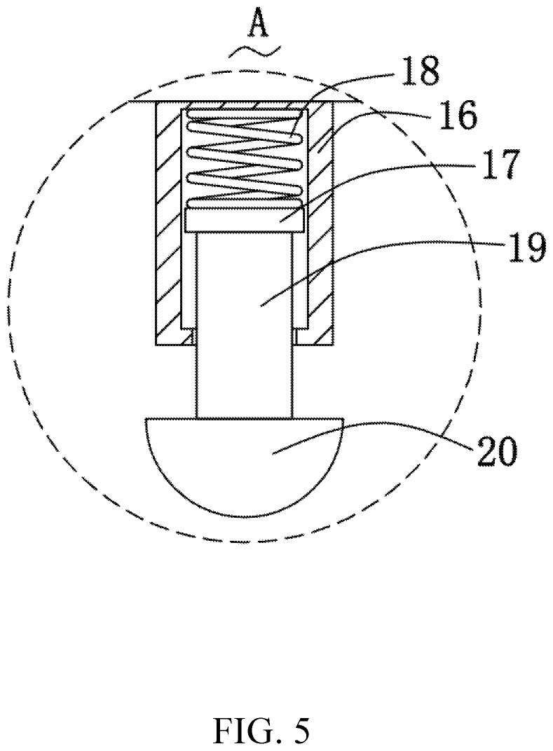

With reference to FIGS. 4-5, the artificial intelligence refrigerated tea table further comprises a bracket mechanism 15 provided at the bottom of the lower housing unit. The bracket mechanism 15 comprises three supporting components, the three supporting components are all fixedly mounted at the bottom of the lower housing unit, the supporting component comprises a mounting block 16, the mounting block 16 is provided with a cavity, a slider 17 is slidingly mounted in the cavity, the cavity is provided with a spring 18, the top end and the bottom end of the spring 18 are fixedly connected to the top end of the cavity 18 and the top of the slider 17, respectively, a slide bar 19 is fixedly mounted at the bottom of the slider 17, and a hemisphere base 20 is fixedly mounted at the bottom end of the slide bar 19.

When the device is transported or the device is placed on an uneven floor, the bracket mechanism 15 in the device will have the corresponding effect of damping or keeping the device horizontal. When the device is transported, the weight of the device will be concentrated on the three supporting components. If there is a bump on the road, the mounting block 16 in the supporting components will increase the stress. The mounting block 16 transmits the stress to the spring 18, and the spring 18 contracts, thereby absorbing a part of the stress, thereby reducing vibration generated during transportation. When the floor is not flat enough, at this time, the spring 18 at a lower terrain will release its elasticity, and push the slider 17 to push the slide bar 19, so as to move the slide bar 19 downward. The slide bar 19 moves downward to drive the hemisphere base 20 to move downward, so that the hemisphere base 20 is in contact with the ground, so that the device can be placed horizontally. The hemisphere base 20 has better adaptability to the flatness of the ground, and the friction between the hemisphere base 20 and the ground is less and it is easier to move during small-scale movement.

The above description is only an embodiment of the present invention, and is not intended to limit the patent scope of the present invention. Any equivalent structure or equivalent flow transformation, which is made by using the description and drawings of the present invention or directly or indirectly applied in other related technical fields, is similarly included in the patent protection scope of the present invention.

What is claimed is:

1. An artificial intelligence refrigerated tea table, comprising:
an upper cover unit;
a lifting unit, which is provided below the upper cover unit, wherein a top end of the lifting unit is connected to the upper cover unit;
a lower housing unit, which is provided below the upper cover unit, wherein a bottom end of the lifting unit is connected to the lower housing unit;
an LED light unit and a button, wherein the LED light unit and the button are both provided on the upper cover unit;
a rotating beverage frame, an audio unit, a charging and USB unit, an artificial intelligence unit, a control unit, an anti-pinch hand unit, a refrigerating unit, a temperature control unit, and a bracket mechanism, wherein the rotating beverage frame, the audio unit, the charging and USB unit, the artificial intelligence unit, the control unit, the anti-pinch hand unit, the refrigerating unit, the temperature control unit, and the bracket mechanism are all provided on the lower housing unit.

2. The artificial intelligence refrigerated tea table according to claim 1, wherein the artificial intelligence unit is connected to the control unit, the control unit is connected to the lifting unit, and a push rod lifting component is provided in the lifting unit.

3. The artificial intelligence refrigerated tea table according to claim 1, wherein the audio unit is connected to the artificial intelligence unit.

4. The artificial intelligence refrigerated tea table according to claim 1, wherein the control unit is connected to the lifting unit.

5. The artificial intelligence refrigerated tea table according to claim 1, wherein the button is connected to the lifting unit.

6. The artificial intelligence refrigerated tea table according to claim 1, wherein the button is connected to the lifting unit.

7. The artificial intelligence refrigerated tea table according to claim 1, wherein the refrigerating unit is connected to the temperature control unit.

8. The artificial intelligence refrigerated tea table according to claim 1, wherein the anti-pinch hand unit is connected to the control unit, and the anti-pinch hand unit has a built-in infrared sensor proximity switch.

9. The artificial intelligence refrigerated tea table according to claim 1, wherein the bracket mechanism is an integrally formed trifurcated leg.

10. The artificial intelligence refrigerated tea table according to claim 1, wherein the bracket mechanism comprises three supporting components, the three supporting components are all fixedly mounted at the bottom of the lower housing unit, the supporting component comprises a mounting block, the mounting block is provided with a cavity, a slider is slidingly mounted in the cavity, the cavity is provided with a spring, the top end and the bottom end of the spring are fixedly connected to the top end of the cavity and the top of the slider, respectively, a slide bar is fixedly mounted at the bottom of the slider, and a hemisphere base is fixedly mounted at the bottom end of the slide bar.
